(19) United States
(12) Patent Application Publication
(10) Pub. No.: US 2008/0078799 A1
(43) Pub. Date: Apr. 3, 2008

(54) Nail Gun with Electric Power Generating Unit

(76) Inventor: Wan-Fu Wen, Taipei Hsien (TW)

Correspondence Address: Wen-Chin Hu, 4331 Stevens Battle Lane, Fairfax, VA, 22033, US

(21) Appl. No.: 11/538,179

(22) Filed: Oct. 3, 2006

(51) Int. Cl. B25C 5/02

(52) U.S. Cl. 227/131

(57) ABSTRACT

A nail gun includes a gun body having an air passage and at least one exhausting hole; a cylinder disposed in the gun body; a piston disposed in the cylinder to divide the cylinder into a top and a bottom chambers, whereby the piston is driven by the high pressure air to move down to hit the nails, and move up to reposition; and an electric power generating unit. The electric power generating unit includes a fan disposed between the top chamber and the exhausting hole, which is rotated once being driven by the high pressure air; at least one magnetic member, a north pole and a south pole of which are switched when induced by the rotation of the fan; and at least one coil, which is able to generate electric power induced by the switch of the north pole and the south pole of the magnetic member.

### BACKGROUND

The present invention relates to nail guns, and more particularly to a pneumatic nail gun with an electric power generating unit that is driven by high pressure air in the nail gun.

Pneumatic nail gun generally utilizes a compressed high pressure air in an air chamber thereof to drive a piston to hit a nail, for join two objects by shooting a nail through both objects, which are widely used in woodworking.

Nowadays, some improved nail guns employ display devices therewith for showing the number of the reserved nails, sound generating devices, caution lights or the like, to increase the function of the nail guns. In order to provide electric power to drive the additional devices, these kinds of nail guns usually dispose housings thereon to accommodate batteries therein for providing electric power. Alternatively, an inverter is disposed on the nail guns to be connected to an outside AC electric power supply for providing electric power.

However, the way of providing electric power by batteries or outside AC electric power supply that described-above are not good enough. The housing for accommodating batteries disposed on the nail guns makes the weight and the volume of the nail guns unduly increased, which makes the heavy nail gun further inconveniently to hold. In use, the inverter has to connect to an outside power supply via a lead, which makes the operator suffer from the obstruction and limitation induced by the lead when he or she operate these nail guns.

Accordingly, what is needed is a pneumatic nail gun that can overcome the above-described deficiencies.

### BRIEF SUMMARY

An exemplary nail gun with an electric power generating unit that is driven by high pressure air in the nail gun, which includes a gun body having a high pressure air passage and at least one exhausting hole connecting to environment therein; a cylinder disposed in the gun body for guiding in high pressure air; a piston disposed in the cylinder to divide the cylinder into a top chamber and a bottom chamber, whereby the piston is driven by the high pressure air to move down to hit the nails, and move up to reposition; and an electric power generating unit.

The electric power generating unit includes a fan disposed between the top chamber and the exhausting hole, which is rotated once being driven by the high pressure air in the top chamber while the piston move up to reposition; at least one magnetic member disposed adjacent to the fan, a north pole and a south pole of which are switched when induced by the rotation of the fan, the magnetic member may be rotatable according to the fan or immovable; at least one coil disposed adjacent to the magnetic member, which is able to generate electric power induced by the switch of the north pole and the south pole of the magnetic member, the coil may be immovable or rotatable according to the fan.

Moreover, the electric power generating unit of the nail gun further includes a storage member for storing the electric power generated by the coil and then providing the electric power to the nail gun.

In additional, the electric power generating unit of the nail gun further includes a circuit board for arranging the generated electric power.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a cross-sectional view of part of a pneumatic nail gun according to an exemplary embodiment of the present invention, showing a first chamber connecting to a trigger valve via a vent hole and a trigger passage;

FIG. 2 is an enlarged view of certain parts of FIG. 1, showing the fan of an electric power generating unit being pivotally attached to an inner surface of a gun body between a guiding hole and a top exhausting hole of the pneumatic nail gun;

FIG. 3 is an enlarged view of the fan of the electric power generating unit of FIG. 1, showing magnetic members respectively disposed in a coaxial frame of the corresponding fan;

FIG. 4 is an enlarged view of coils of the electric power generating unit of FIG. 1, showing the coils being serially connected and surrounding a fixed frame adjacent to the magnetic members;

FIG. 5 is a cross-sectional view of the pneumatic nail gun of FIG. 1, showing the high pressure air being compressed in a main chamber, the first chamber, and a second chamber;

FIG. 6 is a cross-sectional view of the pneumatic nail gun of FIG. 1, showing the high pressure air in the first chamber being discharged via the trigger valve of the nail gun while the trigger is triggered;

FIG. 7 is a cross-sectional view of the pneumatic nail gun of FIG. 1, showing a dish-shaped piston moving up that is driven by the high pressure air so as to drive the hitting piston move down to hit the nails after the trigger is triggered;

FIG. 8 is a cross-sectional view of the pneumatic nail gun of FIG. 1, showing the trigger valve guiding the high pressure air in the main chamber into the first chamber so as to drive the dish-shaped piston move down to reposition for discharging the high pressure air in the top chamber; and

FIG. 9 is an enlarged view of certain parts of the pneumatic nail gun of FIG. 1, showing the high pressure air blowing the fan and inducing it to rotate via passing through from the guiding holes to the exhausting hole.

### DETAILED DESCRIPTION

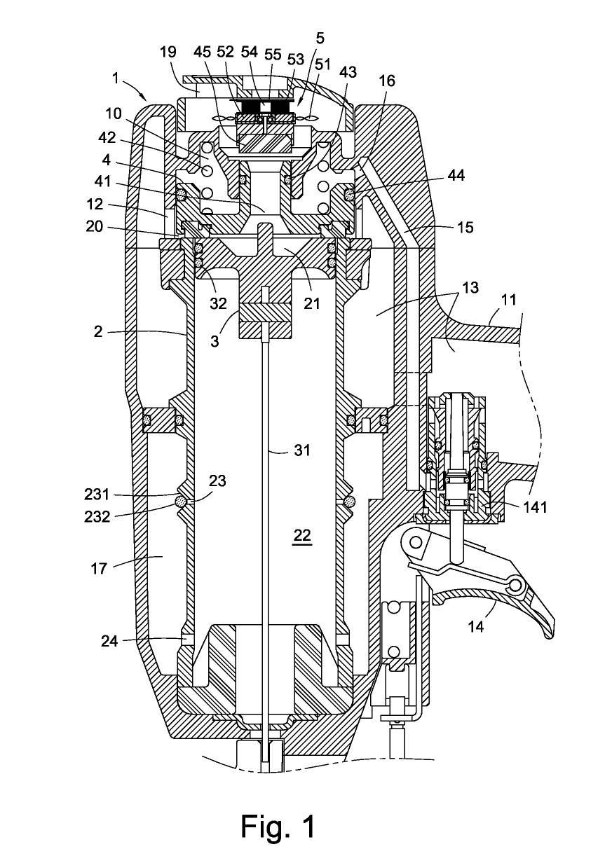

Referring to FIG. 1, a pneumatic nail gun with an electric power generating unit according to an exemplary embodiment of the present invention is shown. The pneumatic nail gun includes a gun body 1, a cylinder 2, a hitting piston 3, a dish-shaped piston 4, and an electric power generating unit 5.

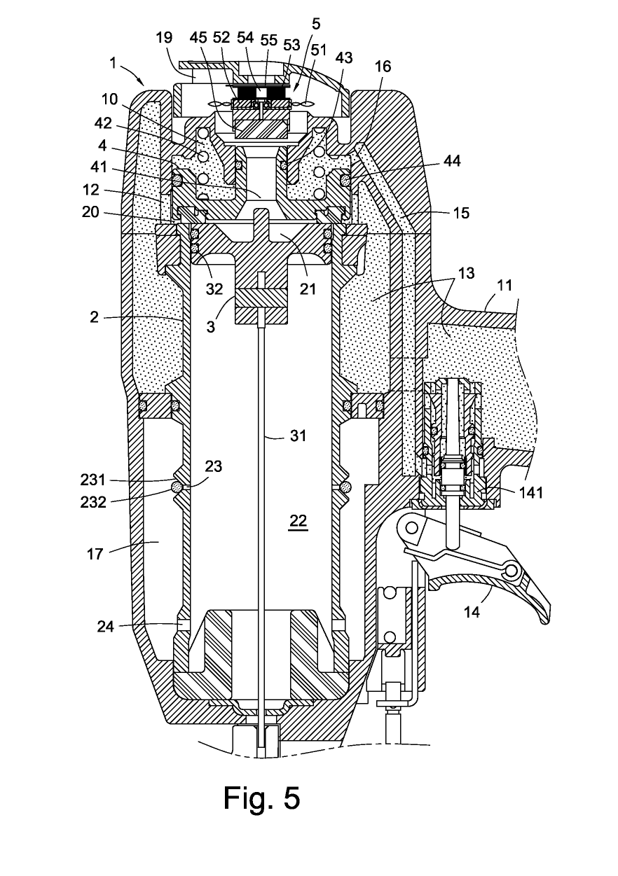

The gun body 1 includes a handle 11 and a main chamber 13 formed in the gun body 1 and the handle 11 for continuously collecting compressed high pressure air therein (as shown in FIG. 5). The gun body 1 further includes an air exhausting hole 19 connecting to environment that is formed at a top portion of the gun body 1, and a trigger 14 disposed at one end of the main chamber 13. Moreover, the trigger 14 has a trigger valve 141 thereof, which is extended into the main chamber 13.

The cylinder 2 is fixed in the gun body 1, and the side wall of the cylinder 2 cooperate with the inner surface of the gun body 1 to form a return chamber 17. The cylinder 2 further includes a ring groove 231 disposed at a middle portion of the outer surface of the cylinder 2, and the ring groove 231 includes a plurality of valve holes 23 connecting the return chamber 17 and the cylinder 2. The cylinder 2 also includes an air-tight ring 232 disposed in the ring groove 231 for closing fluid communication from the return chamber 17 to the cylinder 2 via the valve holes 23. The cylinder 2 includes a plurality of bottom valve holes 24 connecting the return chamber 17 and the cylinder 2, which is disposed at bottom portion of the cylinder 2.

The dish-shaped piston 4 is disposed at the top portion of the cylinder 2, and a first chamber 10 is disposed between the dish-shaped piston 4 and the inner surface of the gun body 1. The first chamber 10 is connected with the trigger valve 141 via a through hole 16 and a trigger passage 15. Then the high pressure air may be transmitted from the main chamber 13 to the first chamber 10 via the trigger valve 141 (as shown in FIGS. 5-7). The high pressure air in the first chamber 10 may discharge or compress to drive the dish-shaped piston 4 to move up or move down, to open or close the fluid communication with the cylinder 2. The dish-shaped piston 4 includes a plurality of air-tight ring 43 and 44 disposed at the outside wall thereof, touching with the inner surface of the gun body 1 to prevent the high pressure air in the first chamber 10 from discharging via the portions except the through hole 16. The first chamber 10 includes a spring 42 therein for abutting the dish-shaped piston 4 downwardly against relative to the top portion of the cylinder 2. A second chamber 20 is formed between the bottom portion of the dish-shaped piston 4 and the top portion of the outside wall of the cylinder 2, which is connected with the main chamber 13 via a plurality of through holes 12 disposed in the gun body 1. The second chamber 20 may continuously collect compressed high pressure air from the main chamber 13 (as shown in FIG. 5).

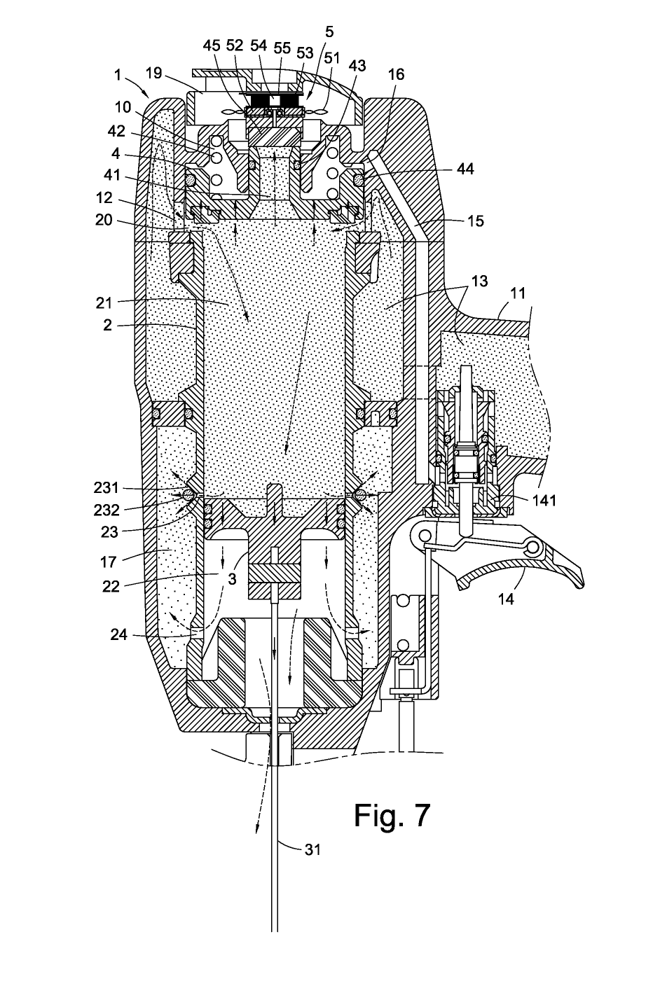

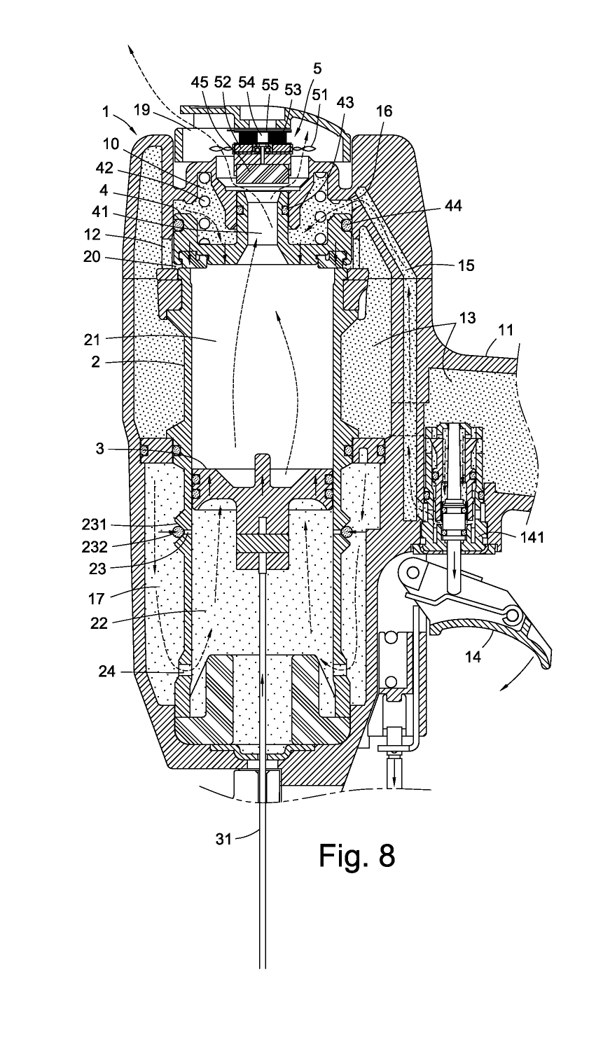

The hitting piston 3 is slidably and reciprocally movably disposed in the cylinder 2 to divide the cylinder 2 into a top chamber 21 and a bottom air chamber 22, and a driver blade 31 extends from a lower end surface (not labeled) of the hitting piston 3. The outside surface of the hitting piston 3 includes at least one air-tight ring 32 for closing fluid communication between the top chamber 21 and the bottom chamber 22 for enabling the hitting piston 3 to be driven by the high pressure air in the top and bottom chambers 21 and 22 to move down to hit the nails or to move up to reposition (as shown in FIGS. 7 and 8).

The dish-shaped piston 4 includes a vent hole 41, and an air-tight washer 45 is fixed to the inner surface of the gun body above the dish-shaped piston 4 and between the vent hole 41 and the air exhausting hole 19. When the dish-shaped piston 4 moves up, the air-tight washer 45 closes the vent hole 41 so as to close the passage between the top chamber 21 and the air exhausting hole 19 (as shown in FIG. 7). When the dish-shaped piston 4 moves down, the vent hole 41 moves away from the air-tight washer 45 so as to open the passage between the top chamber 21 and environment via the air exhausting hole 19. In additional, the dish-shaped piston may replace by a head valve integrated with a top portion of a movable cylinder.

The electric power generating unit 5 includes a fan 51, a plurality of magnetic members 52, and a plurality of coils 53.

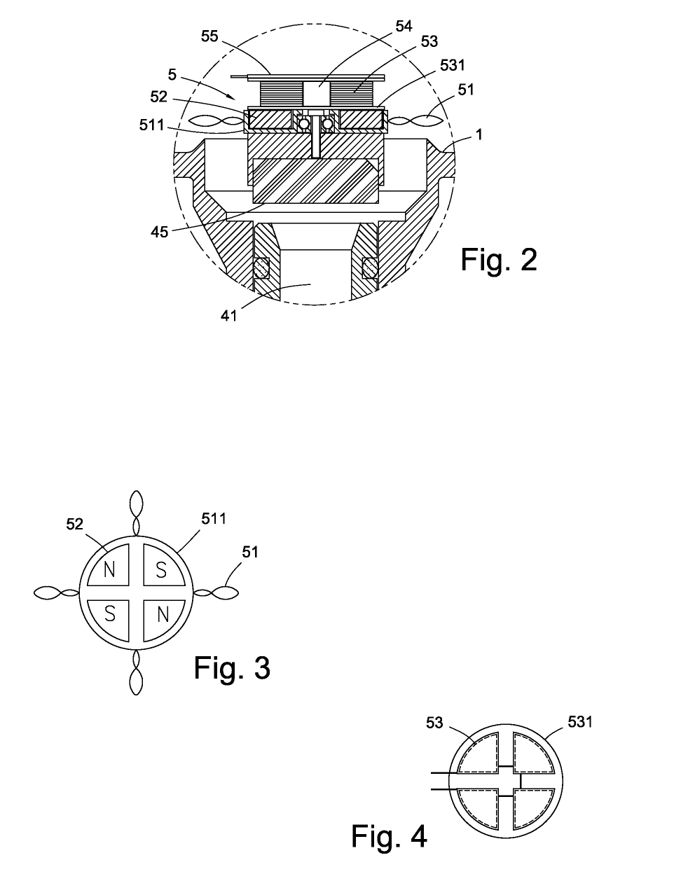

The fan 51 (as shown in FIGS. 2 and 3) is pivotally attached to the inner surface of the gun body 1 between the top chamber 21 and the exhausting hole 19. The fan 51 may also pivotally attached to the inner surface of the gun body 1 between the vent hole 41 of the dish-shaped piston 4 and the exhausting hole 19. The fan 51 is rotated once being driven by the high pressure air transmitting from the top chamber 21 via the vent hole 41 while the hitting piston 3 moves up to reposition.

The magnetic members 52 are respectively disposed in a coaxial frame 511 of the corresponding fan 51, in which, the north pole and the south pole of the magnetic members 52 are alternatively disposed, so that a north pole and a south pole of each of the magnetic members 52 are switched induced according to the rotation of the fan 51. The magnetic members 52 may be magnet. The coils 53 are serially connected and surrounded a fixed frame 531 adjacent to the magnetic members 52 (as shown in FIGS. 2 and 4). The coils 53 may generate electric power induced by the switch of the north pole and the south pole of the magnetic members 52.

Furthermore, the electric power generating unit 5 of the nail gun further includes a storage member 54 (as shown in FIG. 2) for storing the electric power generated by the coils 53 and then providing the electric power to the nail gun. The storage member 54 may be a rechargeable battery. The electric power generating unit 5 of the nail gun may further include a circuit board 55 adjacent to the coils 53 for arranging the generated electric power.

In operation, before the trigger 14 is manipulated as shown in FIG. 5, high pressure air in the main chamber 13 is applied to the first chamber 10 via the trigger valve 141, the trigger passage 15, and the through hole 16, and is applied to the second chamber 20 via the plurality of through holes 12. Therefore, the high pressure air in the first chamber 10 and the top spring 42 drive the dish-shaped piston 4 to move to its lower dead center to close the top end portion of the cylinder 2, so as to close the fluid communication with the cylinder 2.

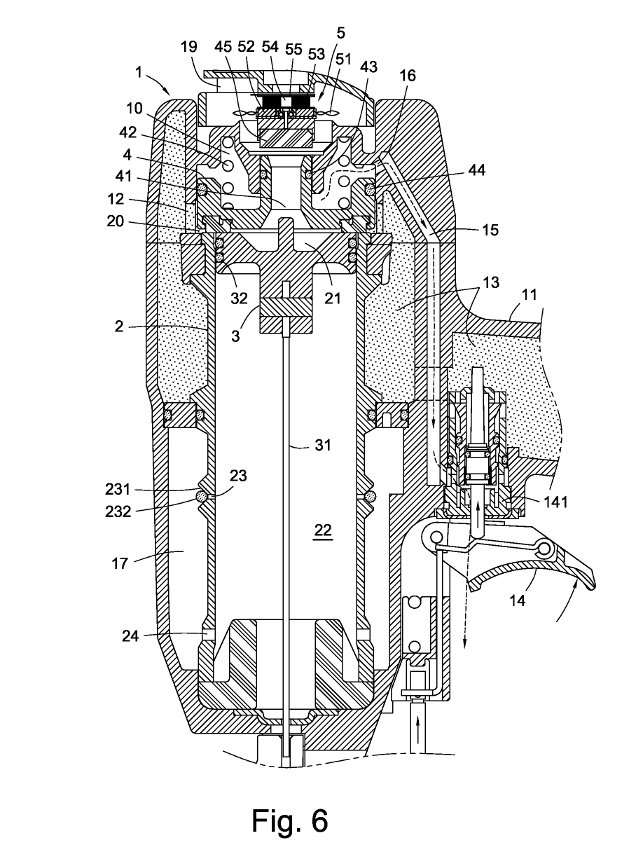

When the trigger 14 is pulled as shown in FIG. 6, the trigger valve 141 closes the fluid communication between the main chamber 13 and the trigger passage 15. Compressed high pressure air in the first chamber 10 is discharged to the environment via the trigger passage 15. At the same time, the high pressure air in the second chamber 20 overcome the force of the spring 42 and drives the dish-shaped piston 4 to move to its upper dead center (as shown in FIG. 7), the air-tight washer 45 closed the vent holes 41 to close the passage from the top chamber 21 to the environment via the vent holes 41 and the exhausting hole 19. Meanwhile, it opens the fluid communication of the top portion of the second chamber 20, and introduces high pressure air into the cylinder 2, applied to the hitting piston 3. Thus, the hitting piston 3 rapidly moves toward the nails. In addition, less part of the residual air in the bottom chamber 22 are discharged to the environment via the hitting hole around the blade 31, and large part of the residual air in the bottom chamber 22 are introduced into the return chamber 17 via the valve holes 24. When the piston 3 moves down to the valve holes 23 of the cylinder 2, the high pressure air in the top chamber 21 may induce the air-tight ring 232 lightly move away from the ring groove 231 so as to introduce the high pressure air in the top chamber 21 into the return chamber 17.

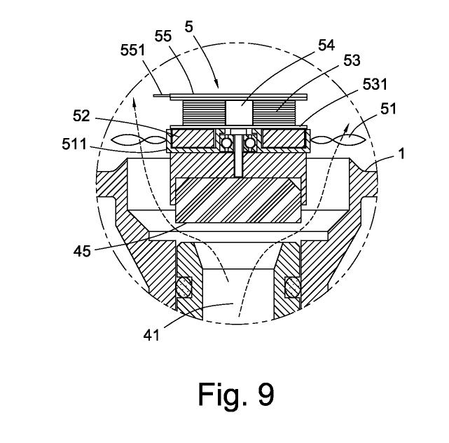

Then, when the user releases the trigger 14 as shown in FIG. 8, the trigger valve 141 returns to the original open state so that the first chamber 10 re-collects high-pressure air. Thus, the dish-shaped piston 4 moves downward to reposition so as to open the passage between the top chamber 21 and the environment via the vent holes 41 and the exhausting holes 19, and close the air communication from the second chamber 20 to the top chamber 21. The high pressure air in the top chamber 21 may discharge to the environment via the vent holes 41 and the exhausting hole 19 so as to rapidly decrease the air pressure in the top chamber 21. The high pressure air in the return chamber 17 are introduced into the bottom chamber 22 via the valve holes 24 to drive the piston 3 to move up to reposition. At this time, the high pressure air discharged to the environment via the vent holes 41 and the exhausting holes 19 may continuously drive the fan 51 to rotate (as shown in FIG. 9), so as to make the magnetic members 52 to rotate for making the coils 53 to generate electric power induced by the switch of the north pole and the south pole of each of the magnetic members 52. The electric power is stored in the storage member 54 or is provided to the nail gun via a lead 551.

When the nail gun is for use in continuously hitting nails, the discharged high pressure air generated by the continuous upwardly moving hitting piston 3 may make the fan 51 continuously rotate, which enable the electric power generating unit continuously to provide electric power to the nail gun. Accordingly, the nail gun may generate electric power by utilizing the discharged high pressure air and provide the electric power to the nail gun without impact the kinetic energy of the operation of hitting nails.

The coils may also dispose in a coaxial frame of the corresponding fan, and the magnetic members may respectively fix to a fixed frame adjacent to the coils. Whereby the north pole and the south pole of each of the magnetic members are alternatively disposed, so that the coils may generate electric power via rotating according to the fans and inducing by the switch of the poles of the magnetic members.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A pneumatic nail gun, comprising:
a gun body having a high pressure air passage and at least one exhausting hole;
a cylinder disposed in the gun body;
a piston disposed in the cylinder to divide the cylinder into a top chamber and a bottom chamber, and the piston being driven by the high pressure air to move down to hit the nails and move up to reposition; and
an electric power generating unit comprising:
a fan disposed between the top chamber and the exhausting hole, wherein the fan is rotated once being driven by the high pressure air in the top chamber while the piston move down to reposition;
at least one magnetic member, a north pole and a south pole of which being switched when induced by the rotation of the fan; and
at least one coil, which being able to generate electric power induced by the switch of the north pole and the south pole of the magnetic member.

2. The pneumatic nail gun as claimed in claim 1, wherein the at least one magnetic member is rotatable according to the fan, and the at least one coil is fixed.

3. The pneumatic nail gun as claimed in claim 1, wherein the at least one magnetic member is fixed, and the at least one coil is rotatable according to the fan.

4. The pneumatic nail gun as claimed in claim 1, wherein the electric power generating unit further comprises a storage member for storing the electric power generated by the at least one coil and then providing the electric power to the nail gun.

5. The pneumatic nail gun as claimed in claim 1, wherein the electric power generating unit further comprises a circuit board for arranging the generated electric power.
